(19) United States
(12) Patent Application Publication
(10) Pub. No.: US 2026/0066321 A1
(43) Pub. Date: Mar. 5, 2026

(54) HIGH EFFICIENCY MICRO-POWER GENERATOR FOR PORTABLE APPLICATIONS

(71) Applicant: ARIZONA BOARD OF REGENTS ON BEHALF OF ARIZONA STATE UNIVERSITY, Scottsdale, AZ (US)

(72) Inventors: Ryan MILCAREK, Gilbert, AZ (US); Gowan ROWLAND, Scottsdale, AZ (US); Tyler SMITH, Phoenix, AZ (US)

(21) Appl. No.: 19/107,265

(22) PCT Filed: Sep. 1, 2023
(86) PCT No.: PCT/US2023/073329

§ 371 Date: Feb. 27, 2025

Related U.S. Application Data
(60) Provisional application No. 63/403,590, filed on Sep. 2, 2022.

(51) Int. Cl. H01M 8/0612; H01M 8/00; H01M 8/04014; H01M 8/04082; H01M 8/12; H01M 16/00

(52) U.S. Cl. CPC H01M 8/0618; H01M 8/004; H01M 8/04014; H01M 8/04201; H01M 16/006; H01M 2008/1293; H01M 2250/30; H01M 2250/402

(57) ABSTRACT

A micro-power generator for portable applications with a micro-scale reformer tube having a diameter of 3 mm or less, a plurality of fuel cells within a main reactor chamber, each of the plurality of fuel cells coupled in a cantilevered fashion at a first end to a substrate, the micro-scale reformer configured to receive a fuel/air mixture through an intake. The micro-power generator receives fuel and converts the fuel within the main reactor to a syngas through use of thermal partial oxidation without subsequent formation of soot, and then electrochemically converts the synthesis gas to generate electricity. The reform reaction is made self-sustaining, at least in part, by the heat introduced to the at least one reformer tube by waste gas expelled into the main reactor chamber when an equivalence ratio is maintained above a threshold ratio.

### RELATED APPLICATIONS

This application claims the benefit of U.S. provisional patent application 63/403,590, filed Sep. 2, 2022 to Rowland, et al., titled “High Efficiency Micro-Power Generator for Portable Applications,” the entirety of the disclosure of which is hereby incorporated by this reference.

### TECHNICAL FIELD

Aspects of this document relate generally to power generation, more specifically to a micro-scale power generator, and more particularly to a robust solid oxide fuel cell design that uses micro-scale thermal partial oxidation and heat recirculation to generate power from hydrocarbon fuels without subsequent formation of soot.

### BACKGROUND

Conventional electricity generation in a small scale with hydrocarbon fuels has been impractical due to size, heat loss, soot production and other challenges. As a result, batteries are the primary source of power used for portable applications, but are limited because the power is used up when the battery is used without the ability to generate more. Applications, such as long-term deployment for military and other applications benefit from the ability to generate replenishable power in remote locations where access to electrical power is not readily available.

Some conventional portable power generation solutions involve solid oxide fuel cells (“SOFC”), but have limited fuel options, generate soot, and are undesirable in many situations. One of the major challenges is the high operating temperature of SOFCs, often in the range of 700 to 1000° C. This high temperature not only limits the choice of materials that can be used in the construction of the fuel cells, but also leads to accelerated degradation of the cell components, particularly the anode. In addition, such high temperatures often lead to the formation of soot, a product of incomplete combustion of hydrocarbons, which can block the fuel cell, reducing its performance and ultimately leading to its premature failure.

In the conventional structure of a SOFC power generation system, the SOFC system itself supplies water and fuel for steam reforming. The fuel and water are preheated and sent to a reformer where the steam reforming reactions occur. Subsequently, the byproducts, in the form of a hydrogen-rich mixture, is then sent into the fuel cell. However, to avoid these complexities as well as the additional weight of the needed water, alternative conventional SOFC power generation systems use a catalyst instead of steam reforming. Utilizing catalysts, however, introduces additional complexity and cost, as catalysts are typically expensive and necessitate extra processing steps.

### SUMMARY

Aspects of this disclosure relate to a micro-power generator for portable applications, comprising a generator housing with fluid fuel inlet comprising a fuel canister connector on a surface of the generator housing, a main reactor chamber within the generator housing, a micro-scale reformer comprising an intake, an exhaust, and at least one reformer tube that extends through the main reactor chamber, the micro-scale reformer configured to receive a fuel/air mixture having a flow rate and an equivalence ratio through the intake, and expel hydrogen-rich synthesis gas through the exhaust, the hydrogen-rich synthesis gas produced within the micro-scale reformer through a reform reaction, the at least one reformer tube each having a diameter of 3 mm or less, and a wall temperature, a plurality of tubular fuel cells within the main reactor chamber, each of the plurality of fuel cells coupled in a cantilevered fashion at a first end to a substrate such that a second end of each of the plurality of fuel cells, distal from the first end, is unattached from the main reactor chamber except through its association with the first end, the plurality of tubular fuel cells configured to generate electricity, heat, and a waste gas through an electrochemical reaction with the hydrogen-rich synthesis gas received from the micro-scale reformer, the waste gas being expelled into the main reactor chamber through the second end of each tubular fuel cell, a power supply port accessible at a surface of the generator housing and configured to provide access to the electricity generated by the micro-power generator, and a USB port accessible at a surface of the generator housing and configured to provide access to the electricity generated by the micro-power generator, wherein the micro-power generator is configured to receive fuel through a fluid fuel inlet and convert the fuel to a hydrogen-rich synthesis gas through use of thermal partial oxidation without subsequent formation of soot, wherein the wall temperature is less than a critical temperature, and wherein the reform reaction is made self-sustaining, at least in part, by the heat introduced to the at least one reformer tube by the waste gas expelled into the main reactor chamber when the equivalence ratio is maintained above a threshold ratio.

Particular embodiments may comprise one or more of the following features. A fan coupled to the generator housing and configured to introduce ambient air into the main reactor chamber by drawing air through the intake. The fuel may be selected from the list comprising methane, natural gas, ethane, propane, butane and jet fuel. The micro-power generator is insensitive to system orientation. The micro-power generator is part of a system further comprising a fuel canister configured to couple to the fuel canister connector, an intake hose configured to couple to the air intake, an exhaust hose configured to couple to an air exhaust on the generator housing, a wearable battery, and a power cable configured to electrically couple to the power supply port. The system may have a total system weight of less than 6 lbs. The generator housing may comprise an outer diameter less than or equal to 3.5 inches and a length of less than or equal to 6.9 inches. The micro-power generator may be configured to maintain the wall temperature below the critical temperature, at least in part, by modifying the flow rate. The critical temperature may be 900° C. The threshold ratio is 2.5. The reformer tube diameter is less than a quenching diameter of the at least one reformer tube.

Aspects of this disclosure relate to a micro-power generator for portable applications, comprising a main reactor chamber, a micro-scale reformer comprising at least one reformer tube that extends through the main reactor chamber, the micro-scale reformer configured to receive a fuel/air mixture having a flow rate and an equivalence ratio through an intake, and expel syngas through an exhaust, a plurality of fuel cells within the main reactor chamber, each of the plurality of fuel cells coupled in a cantilevered fashion at a first end to a substrate such that a second end of each of the plurality of fuel cells, distal from the first end, is unattached from the main reactor chamber except through its association with the first end, the plurality of tubular fuel cells configured to generate electricity, heat, and a waste gas through an electrochemical reaction with the syngas received from the micro-scale reformer, the waste gas being expelled into the main reactor chamber through the second end of each tubular fuel cell, wherein the reform reaction is made self-sustaining, at least in part, by the heat introduced to the at least one reformer tube by the waste gas expelled into the main reactor chamber when the equivalence ratio is maintained above a threshold ratio, and wherein the micro-power generator is configured to electrochemically convert the hydrogen-rich synthesis gas to generate electricity.

Particular embodiments may comprise one or more of the following features. A generator housing surrounding the micro-scale reformer, the plurality of fuel cells, the micro-power generator further comprising a fuel canister configured to couple to a fluid fuel inlet on the generator housing, an intake hose configured to couple to an air intake on the generator housing, an exhaust hose configured to couple to an air exhaust on the generator housing, a wearable battery, and a power cable configured to electrically couple to a power supply port on the generator housing and transfer electricity generated by the micro-power generator to the wearable battery. The fluid fuel may be selected from the list comprising methane, natural gas, ethane, propane, butane and jet fuel. A generator housing surrounding the micro-scale reformer and the plurality of fuel cells, the micro-power generator housing comprising an outer diameter less than or equal to 3.5 inches and a length of less than or equal to 6.9 inches. The at least one reformer tube each having a diameter of 3 mm or less.

Aspects of this disclosure relate to a method for generating power for portable applications using a micro-power generator, comprising introducing a fuel/air mixture having a flow rate and an equivalence ratio to an intake of a micro-scale reformer enclosed inside the micro-power generator, the micro-scale reformer comprising at least one reformer tube passing through a main reactor chamber enclosed within the micro-power generator, the at least one reformer tube having a reformer tube diameter and a wall temperature, producing syngas by initiating a reform reaction within the micro-scale reformer, the syngas produced by the reform reaction being expelled through an exhaust of the micro-scale reformer, generating electricity, heat, and a waste gas through an electrochemical reaction within a plurality of tubular fuel cells, each tubular fuel cell of the plurality of tubular fuel cells comprising a first end, a lumen in fluidic communication with the exhaust of the micro-scale reformer through the first end, and a second end distal to the first end and cantilevered into the main reactor chamber, wherein the electrochemical reaction comprises the syngas being received into the lumen of each tubular fuel cell through the first end and the waste gas being expelled into the main reactor chamber through the second end, inhibiting the production of soot within the micro-scale reformer by maintaining the wall temperature of the at least one reformer tube below a critical temperature, and making the reform reaction self-sustaining, at least in part, by elevating and maintaining the equivalence ratio above a threshold ratio, thereby causing the heat introduced to the at least one reformer tube via the waste gas produced by the electrochemical reaction and expelled into the main reactor chamber to be sufficient to make the reform reaction superadiabatic combustion.

Particular embodiments may comprise one or more of the following features. The at least one reformer tube passes through the main reactor chamber more than once. The wall temperature of the at least one reformer tube is maintained below the critical temperature, at least in part, by modifying the flow rate. The fuel/air mixture may comprise one of methane, natural gas, ethane, propane, butane, and jet fuel.

Aspects and applications of the disclosure presented here are described below in the drawings and detailed description. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors'intent and desire that the simple, plain and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S. C. § 112(f). Thus, the use of the words “function,” “means” or “step” in the Detailed Description or Description of the Drawings or claims is not intended to somehow indicate a desire to invoke the special provisions of 35 U.S. C. § 112(f), to define the invention. To the contrary, if the provisions of 35 U.S. C. § 112(f) are sought to be invoked to define the inventions, the claims will specifically and expressly state the exact phrases “means for” or “step for”, and will also recite the word “function” (i.e., will state “means for performing the function of [insert function]”), without also reciting in such phrases any structure, material or act in support of the function. Thus, even when the claims recite a “means for performing the function of . . . ” or “step for performing the function of . . . ” if the claims also recite any structure, material or acts in support of that means or step, or that perform the recited function, then it is the clear intention of the inventors not to invoke the provisions of 35 U.S. C. § 112(f). Moreover, even if the provisions of 35 U.S. C. § 112(f) are invoked to define the claimed aspects, it is intended that these aspects not be limited only to the specific structure, material or acts that are described in the preferred embodiments, but in addition, include any and all structures, materials or acts that perform the claimed function as described in alternative embodiments or forms of the disclosure, or that are well known present or later-developed, equivalent structures, material or acts for performing the claimed function.

The foregoing and other aspects, features, and advantages will be apparent from the DESCRIPTION and DRAWINGS, and from the CLAIMS if any are included.

### BRIEF DESCRIPTION OF THE DRAWINGS

Implementations will hereinafter be described in conjunction with the appended and/or included DRAWINGS, where like designations denote like elements, and:

FIG. 1. is a perspective view of a high efficiency micro-power generator;

FIG. 2 is perspective view of the high efficiency micro-power generator of FIG. 1 with the generator housing shown transparent;

FIG. 3 is a perspective view of the high efficiency micro-power generator of FIG. 1 with the generator housing and shroud removed;

FIG. 4 is a side view of an embodiment of a high efficiency micro-power generator of FIG. 1;

FIG. 5 is a top view of an embodiment of a high efficiency micro-power generator of FIG. 1;

FIG. 6 is a cross-sectional view of the high efficiency micro-power generator of FIG. 5 taken along section line A-A;

FIG. 7 is a magnified cross-sectional view of a tubular fuel cell;

FIG. 8 is a process flow in the context of the cross-sectional view of the high efficiency micro-power generator similar to that of FIG. 6;

FIG. 9 is a plot diagram showing the SOFC power density over time for a particular embodiment of the high efficiency micro-power generator; and

FIG. 10 is a perspective view of a micro-power generator system.

FIG. 11 is a representation of a soldier wearing the high efficient micro-power generator system of FIG. 8 with portions of the soldier's rucksack and uniform removed to show the system within the rucksack and uniform.

### DETAILED DESCRIPTION

Detailed aspects and applications of the disclosure are described below in the following drawings and detailed description of the technology. Unless specifically noted, it is intended that the words and phrases in the specification and the claims be given their plain, ordinary, and accustomed meaning to those of ordinary skill in the applicable arts.

In the following description, and for the purposes of explanation, numerous specific details are set forth in order to provide a thorough understanding of the various aspects of the disclosure. It will be understood, however, by those skilled in the relevant arts, that embodiments of the technology disclosed herein may be practiced without these specific details. It should be noted that there are many different and alternative configurations, devices and technologies to which the disclosed technologies may be applied. The full scope of the technology disclosed herein is not limited to the examples that are described below.

The singular forms “a,” “an,” and “the” include plural referents unless the context clearly dictates otherwise. Thus, for example, reference to “a step” includes reference to one or more of such steps.

The word “exemplary,” “example,” or various forms thereof are used herein to mean serving as an example, instance, or illustration. Any aspect or design described herein as “exemplary” or as an “example” is not necessarily to be construed as preferred or advantageous over other aspects or designs. Furthermore, examples are provided solely for purposes of clarity and understanding and are not meant to limit or restrict the disclosed subject matter or relevant portions of this disclosure in any manner. It is to be appreciated that a myriad of additional or alternate examples of varying scope could have been presented, but have been omitted for purposes of brevity.

When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

Throughout the description and claims of this specification, the words “comprise” and “contain” and variations of the words, for example “comprising” and “comprises”, mean “including but not limited to”, and are not intended to (and do not) exclude other components.

As required, detailed embodiments of the present disclosure are included herein. It is to be understood that the disclosed embodiments are merely exemplary of the invention that may be embodied in various forms. Therefore, specific structural and functional details disclosed herein are not to be interpreted as limits, but merely as a basis for teaching one skilled in the art to employ the present invention. The specific examples below will enable the disclosure to be better understood. However, they are given merely by way of guidance and do not imply any limitation. The present disclosure may be understood more readily by reference to the following detailed description taken in connection with the accompanying figures and examples, which form a part of this disclosure. It is to be understood that this disclosure is not limited to the specific materials, devices, methods, applications, conditions, or parameters described and/or shown herein, and that the terminology used herein is for the purpose of describing particular embodiments by way of example only and is not intended to be limiting of the claimed inventions. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

### Overview and Advantages

The present disclosure, including the related Figures, describes key advances in reforming, heat recovery, and design to accommodate the compact design of a high efficiency micro-power generator for portable applications. A heat recovery mechanism is disclosed which integrates the micro-reformer into a solid oxide fuel cell (“SOFC”) exhaust for self-sustained reforming. Aspects of the disclosure relate small (sub-50 W) thermally integrated passive SOFCs that are lightweight and can achieve high electrical efficiency. Other aspects relate to key advances in reforming, heat recovery, and design to accommodate the compact design of the system. A heat recovery mechanism is disclosed which integrates the micro-reformer into the SOFC exhaust for self-sustained reforming.

Specifically, the balance of the SOFC plant has been re-formulated compared to a conventional SOFC, with no steam reformer or reforming catalyst, and the heat exchanger has been simplified in order to reduce cost, complexity and weight. Regardless of the fuel, thermal partial oxidation generates hydrogen and carbon monoxide (i.e., synthesis gas) at high fuel/air ratios without soot particles forming. The micro-scale (3mm reactor diameter) partial oxidation reformer succeeds where previous thermal partial oxidation reformers failed because of the lack of soot formation as a result of limited residence time and temperature control. Specifically, at reforming temperatures below 900° C., precursor formation is not favorable which prevents soot particle formation. Achieving thermal partial oxidation without soot formation was typically limited to fuel/air equivalence ratios less than 1.6 for conventional fuels due to the onset of soot formation.

Embodiments of the disclosure achieve a 20-30 W thermally integrated passive SOFC that weighs less than 6 lbs and can achieve over 20% electrical efficiency with an estimated specific energy exceeding 700 Wh/kg (for a 72 hour mission, compared to 50-260 Wh/kg for Li-ion batteries) and power density exceeding 400 Wh/L for a 72 hour mission. There are three key advancements described more in the detailed description below: 1) micro-scale thermal partial oxidation; 2) robust power generator design; and 3) heat recirculation.

It should be noted that while many of the examples and use cases discussed below are presented in the context of military applications, the micro-power generator, system, and method of operation contemplated herein may be applied in a wide range of other industries and activities. Although the contemplated generator is well-adapted for use in a military setting due to its simplicity, efficacy, longevity, and robust design, those benefits may be reaped in many other use cases. The examples provided herein are non-limiting.

There are current fuel cell systems being developed for portable and wearable applications with the specific target of generating 12-20 V of power to charge a battery. Requirements include low system weight and volume relative to the run-time, low acoustic signature, low thermal signature, ruggedized design with rapid startup capability and fuel flexibility. The current systems being developed have limited fuel flexibility, primarily because the fuel cell technology (i.e., Polymer Electrolyte Membrane) has limited ability to convert carbon-based fuels. Presently disclosed embodiments utilize an SOFC with reduced system complexity that yields high specific energy and energy density, while also having significant fuel flexibility. The simplifications and robust micro-tubular SOFC design offer rapid startup capabilities, overcoming one of the main obstacles in previous SOFC systems for Army applications that required over 20 min to reach operating conditions.

### Particular Embodiments Details

Conventional electricity generation in a small scale with hydrocarbon fuels has been impractical due to heat loss and other challenges, leaving batteries as the only viable alternative for small-scale power generation. Achieving high specific energy and power density requires an alternative approach to a high efficiency micro-power generator system design. Instead of utilizing a catalyst for hydrocarbon reforming, requiring water for steam/autothermal reforming, or using a heavy metal hydride cylinder as conventional SOFCs require, embodiments of the presently disclosed systems use a micro-scale thermal partial oxidation reformer. Micro-scale reformers described herein are lightweight, only require fuel/air mixtures, have been demonstrated to achieve significant fuel flexibility (methane and natural gas, ethane, propane, butane) and are expected to operate with jet fuel.

Many conventional SOFC systems used by the Army have limited fuel options. By enabling multi-fuel capability in an SOFC, especially with JP-8 or windshield washer fluid, significantly improves applicability and use case scenarios. A micro-reformer converts hydrocarbons into hydrogen-rich synthesis gas (“syngas”) without subsequent formation of soot. The syngas may then be electrochemically converted to generate electricity in the passive SOFC, while heat recovery sustains the micro-scale reformer.

Compared to other conventional small scale fuel cell generators, the present disclosure of a high efficiency micro-power generator for portable applications offers several system simplifications. Specifically, compared with a conventional SOFC, the balance of the SOFC plant has been re-formulated with no steam reformer or reforming catalyst, and the heat exchanger has been simplified in order to reduce cost, complexity and weight. Regardless of the fuel, thermal partial oxidation generates hydrogen and carbon monoxide (i.e., synthesis gas) at high fuel/air ratios without soot particles forming. By using the thermal partial oxidation, there is no need for steam or a steam reformer. As a result, the water supply, reformer and heat exchanges needed for preheating in a traditional SOFC system are eliminated, and it is accomplished without the use of a catalyst. This reduces complexity, size and cost.

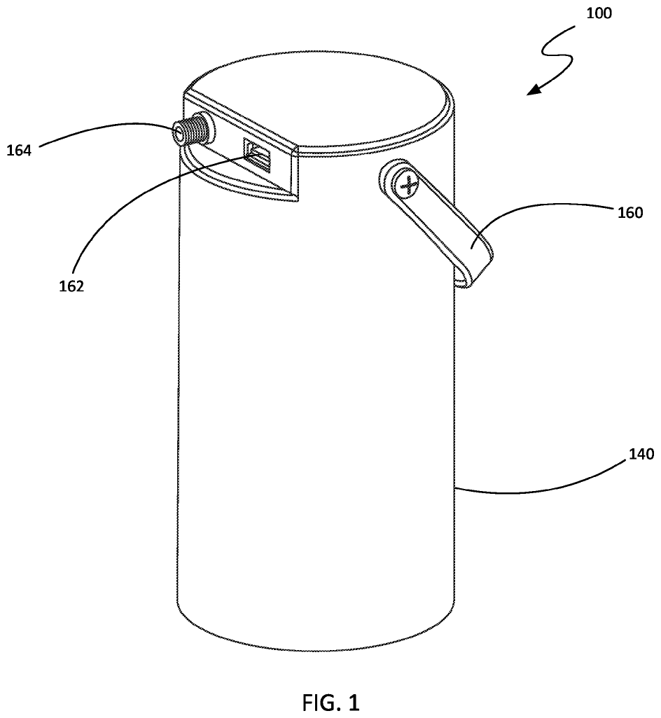

FIGS. 1-8 illustrate non-limiting examples of an embodiment of a high efficiency micro-power generator 100 (or “generator 100” or “SOFC generator 100”) for portable applications according to various embodiments. FIG. 1 in particular illustrates a perspective view of a generator 100 that includes a generator housing 140, which may serve as a protective shell for the internal components, and provide surfaces for mounting interfaces for various inputs and outputs, a USB port 162 configured to charge electronics, and a power supply port 164 configured to provide electrical power to external devices such as a battery (e.g., a threaded port for securely connecting a power cable that can remain connected while the generator 100 is being moved, etc.). This particular embodiment is embodied as an SOFC generator 100.

According to various embodiments, the micro-power generator 100 comprises a micro-scale reformer 104 coupled to a plurality of tubular fuel cells 124. According to various embodiments, the micro-scale reformer 104 and the plurality of tubular fuel cells 124 are enclosed within a main reactor chamber 102 of the micro-power generator 100, which helps with repurposing the heat generated by these elements during power generation. Each of these elements will be discussed in turn, below.

The housing 140 may be composed of a lightweight yet strong material such as a thermoplastic, metal, carbon fiber or similar fiber-based material, and the like. Those skilled in the art will recognize that the material of the housing 140 may depend on the intended fuel, as some materials may not be compatible with some potential fuels. In other embodiments, the housing 140 may be composed of any other appropriate material known in the art.

In some embodiments, the generator 100 may be shaped and/or given features to enhance its portability. As shown, in some embodiments a handle 160 or handle strap may be coupled to the housing 140. In other embodiments, the housing may comprise one or more receivers, clips, rings, and the like, to assist with mounting or otherwise securing the generator 100. As a specific example, in one embodiment the housing 140 may comprise attachments that are compatible with a standardized military attachment system such as MOLLE (Modular Lightweight Load-carrying Equipment) or PALS (Pouch Attachment Ladder System).

The non-limiting example of a micro-power generator 100 shown in FIG. 1 is cylindrical. In other embodiments, the housing may have other shapes that may be better suited for particular use cases. The shape of the housing may be optimized depending on a number of factors including, but not limited to, need for heat dissipation, storage needs, method of transport, capacity, and the like.

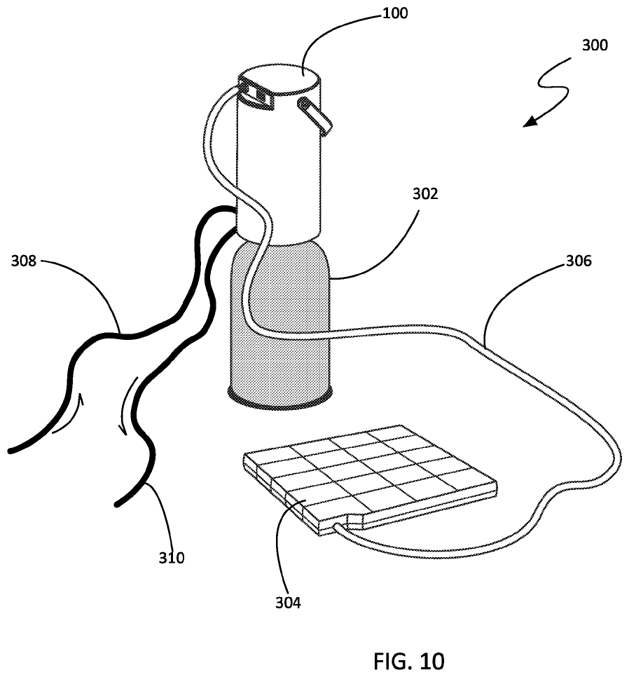

According to various embodiments, the micro-power generator 100 contemplated herein may be sized to provide sufficient power for, and be easily carried by, a single person. As a specific, non-limiting example, in one embodiment the housing 140 may be cylindrical, with an outer diameter 144 less than or equal to 3.5 inches, and a height 146 of less than or equal to 6.9 inches. As will be discussed in greater detail with respect to FIG. 10, a micro-power generator 100 fitting these dimensional constraints may be adapted to meet a specific power need for a military use case. In other embodiments, the housing 140 may be smaller, while in still other embodiments, the housing may be larger. It should be noted that may of the advantageous abilities of the contemplated generator 100 stem from the micro-scale of the reformer 104 and the tubular fuel cells 124, and that while the generator 100 could be scaled up to fill a larger housing 140, some of the components may reach a size limit (e.g., the quenching diameter of the reformer tube 106, etc.), and instead need to be increased in number, rather than size.

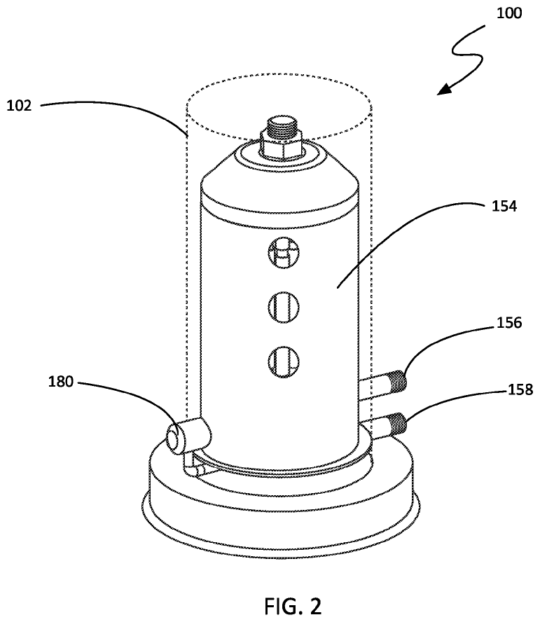

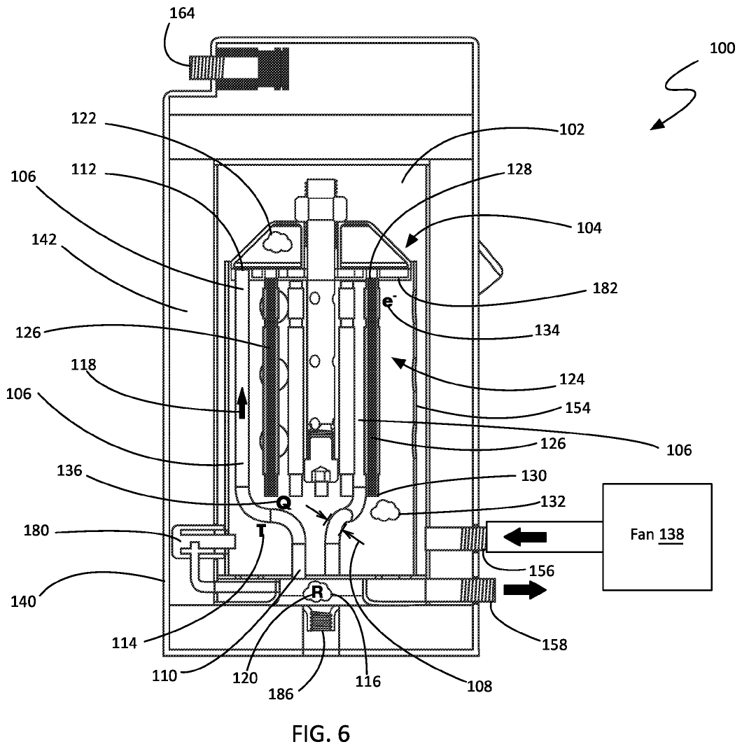

FIG. 2 is the same perspective view as was shown in FIG. 1, but with the housing 140, insulation 142, and various electrical components such as the power supply port 164 and the USB port 162 removed. The dashed line indicates the boundary of the main reactor chamber 102. In the context of the present description and the claims that follow, a main reactor chamber 102 is a hollow space within the housing 140 or otherwise enclosed within the micro-power generator 100 that contains the micro-scale reformer 104 and the plurality of tubular fuel cells 124, and a pre-heating burner 180. according to various embodiments. In some embodiments, the main reactor chamber 102 is surrounded by insulation 142 (FIG. 6), to help with heat reclamation. In other embodiments, the main reactor chamber 102 may simply be defined by the generator housing 140.

As shown, the micro-power generator 100 comprises an intake port 156 and an exhaust port 158, according to various embodiments. In the context of the present description and the claims that follow, an intake port 156 is a port or other opening or fixture through which air (e.g., atmospheric or ambient air, compressed air, etc.) may be introduced to the main reactor chamber 102. In some embodiments, the intake port 156 may permit the direct introduction of air to the main reactor chamber 102, while in other embodiments, there may be a valve or similar gating mechanism built into the micro-power generator 100 that can control the air flow. In some of the embodiments with a direct connection, a form of control may be provided from outside the housing 140 of the micro-power generator 100.

In some embodiments, air may be pulled or sucked in through the intake port 156 due to gas being introduced to the intake 110 of the micro-scale reformer 104 at a flow rate. In other embodiments, air may be pushed or blown in from outside the housing 140 by a fan 138 or similar device that is in fluidic communication with the main reactor chamber 102. See, for example, the fan 138 of FIG. 6.

In the context of the present description and the claims that follow, an exhaust port 158 is a port of other opening or fixture through which gas inside the main reactor chamber 102 may be expelled out of the micro-power generator 100. In some embodiments, the exhaust port 158 may permit the direct ejection of gas (e.g., waste gas 132, etc.) from the main reactor chamber 102, while in other embodiments, there may be a valve or similar gating mechanism built into the micro-power generator 100 that can control the gas flow. In some of the embodiments with a direct connection, that form of control may be provided from outside the housing 140 of the micro-power generator 100.

In some embodiments, the space between walls of the main reactor chamber 102 (i.e., the dashed lines of FIG. 2) and the components at the core of the main reactor chamber 102 (i.e., the micro-scale reformer 104 and the plurality of tubular fuel cells 124) may be partitioned by a shroud 154, as shown in FIG. 2. According to various embodiments, the shroud 154 helps with heat recovery. More specifically, the shroud 154 helps transfer heat from the hot elements inside the shroud 154 (e.g., the tubular fuel cells 124, waste gas 132, etc.) to the air being brought into the main reactor chamber 102 through the intake port 156.

According to various embodiments, the shroud 154 comprises a plurality of holes or apertures that allow gas to pass through the shroud 154. In some embodiments, including the non-limiting example shown, the path within the main reactor chamber 102 that runs between the intake port 156 and the exhaust port 158 passes through these holes in the shroud 154, ensuring sufficient contact to transfer at least a portion of the heat 136. As shown in the cross-sectional view of FIG. 6, in some embodiments, the internal openings (i.e., the opening that is inside the housing 140) of the intake port 156 and the exhaust port 158 are on opposite sides of the shroud 154, with the intake port 156 on the outside of the shroud 154 and the exhaust port 158 on the inside of the shroud 154. A liquid fuel canister connector 186 is accessible from a surface of the generator housing 140.

As an option, in some embodiments, the holes may be positioned on the shroud 154 further away from one or both of the ports, thereby extending the path and prolonging the gas contact with the shroud 154, increasing heat transfer. See, for example, the holes in the shroud 154 shown in FIG. 2 which are on the upper end of the shroud 154, forcing the air coming in through the intake port 156 to travel up along the shroud 154 until a hole is reached.

This heat transfer serves two purposes. It warms up the incoming air that will be mixed with fuel, which enhances the reform reaction. It also helps maintain the wall temperature of the reformer tubes 106. As will be discussed below, maintaining the wall temperature of the reformer tubes 106 below a critical temperature inhibits the formation of soot, extending the lifespan of the generator 100 and permitting the use of hydrogen-rich syngas 122 that is problematic in conventional SOFC-based generators.

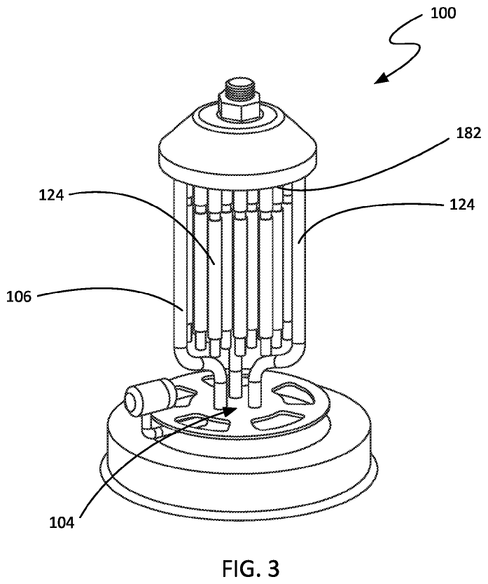

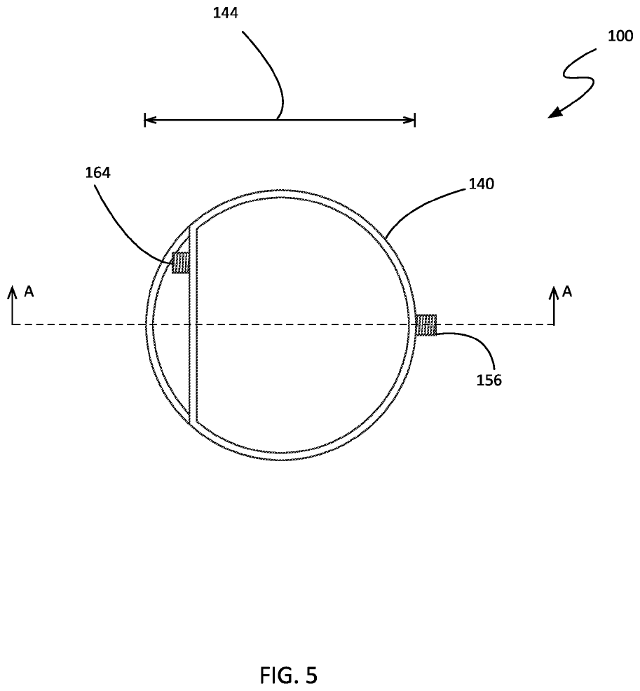

FIG. 3 shows the same perspective view seen in FIGS. 1 and 2, with the shroud 154 and the walls of the main reactor chamber 102 removed, revealing the micro-scale reformer 104 and the plurality of tubular fuel cells 124. These elements are also shown in FIG. 6, which is a cross-sectional view of that same non-limiting example of a micro-power generator 100, viewed along A-A of FIG. 5. The micro-scale reformer 104 and the plurality of tubular fuel cells 124 are the heart of the contemplated generator 100, and provide numerous advantages over conventional power generators.

According to various embodiments, the micro-scale reformer 104 comprises an intake 110, an exhaust 112, and at least one reformer tube 106 having a reformer tube diameter 108. The micro-scale reformer 104 receives a fuel/air mixture 116 through the intake 110. This fuel/air mixture 116 has a flow rate and an equivalence ratio (i.e., a volumetric flow rate comparison between the ratio of the actual fuel-to-air ratio in a fuel/air mixture to the stoichiometric fuel-to-air ratio for that mixture). Within a reformer tube 106, the fuel/air mixture 116 undergoes a reform reaction producing syngas 122 which is expelled through the exhaust 112 of the micro-scale reformer 104.

As is known in the art, reformers may employ a variety of reform reactions, such as steam reformation or catalyst-driven reformation. In the contemplated micro-power generator 100, the reform reaction is a thermal partial oxidation of the fuel/air mixture 116, without the use of water, steam, or a catalyst. As will be discussed below, the contemplated generator 100 is able to make this reform reaction self-sustaining, such that it only needs to be provided fuel and air to continue generating syngas 122. In other words, while the reform reaction is self-sustaining, it does not require the addition of external energy (e.g., additional heat) to continue. While beneficial in any circumstance, a self-sustaining reform reaction is particularly advantageous when the reform reaction is occurring in an environment that would otherwise require additional energy.

According to various embodiments, the at least one reformer tube 106 passes through the main reactor chamber 102. It should be noted that in some embodiments, there is little distinction between the micro-scale reformer 104 and the at least one reformer tube 106 that it comprises (i.e., embodiments where there is only one reformer tube 106). In other embodiments, the micro-scale reformer 104 may comprise more than one reformer tube 106. Multiple reformer tubes 106 may share a single intake 110 and/or exhaust 112. Splitting the micro-scale reformer 104 into multiple reformer tubes 106 may be advantageous for the purposes of repurposing heat 136 generated by the tubular fuel cells 124 and the combustion process, as well as thermal control of the tube wall temperatures. Repurposing heat 136 and maintaining the wall temperature each may lead to significant benefits not found in conventional generators. Each will be discussed below.

In the context of the present description and the claims that follow, the “micro-scale” in the name micro-scale reformer 104 is referring to the reformer tube diameter 108 of the at least one reformer tube 106 belonging to the reformer 104. The use of very small reformer tubes 106 makes it possible to generate hydrogen-rich syngas 122 without making soot, something not possible in conventional generators. According to various embodiments, the reformer tube diameter 108 of the at least one reformer tube 106 of a micro-scale reformer 104 is less than the quenching diameter of the at least one reformer tube 106. In other words, the reformer tube diameter 108 is less than the quenching diameter of a tube in the same use environment as the at least one reformer tube 106 of that particular embodiment's micro-scale reformer 104.

The quenching diameter of a tube is the smallest tube diameter that can sustain a flame inside. If the diameter of the tube is smaller than the quenching diameter, the flame will extinguish, or “quench.” The quenching diameter is determined by a number of factors including, but not limited to, fuel type, fuel/air mixture composition, temperature, pressure, and tube wall material (e.g., thermal properties of the wall material, etc.). Thus, among the different embodiments of the contemplated micro-power generator 100 where the reformer tube diameter 108 is less than the quenching diameter, there is a range of reformer tube diameters 108 that depend on the specifics of each particular embodiment.

Some embodiments of the micro-power generator 100 are able to use different fuels, and may operate within a temperature range, leading to a range of quenching diameters rather than a single diameter that functions as a limit. In some of these embodiments, it may be easier to identify a specific limit for the reformer tube diameter 108, rather than defining it through a quantity that may have a spectrum of values. For example, in some embodiments, the reformer tube diameter 108 is no greater than 3 mm. In other embodiments, the reformer tube diameter 108 is less than 2 mm. In still other embodiments, the reformer tube diameter 108 is less than 1 mm. The quenching diameter is typically between 1 mm and 3 mm for most fuels, in common use environments. However, some embodiments of the contemplated micro-power generator 100 may be adapted for use with atypical fuels and/or operating environments, and may have quenching diameters outside this range (e.g., in some embodiments, the reformer tube diameter 108 may be greater than 3 mm, etc.).

Traditional thermal partial oxidation reformers are full scale burners-not used for small scale reforming. Traditional scale burners can only operate at equivalence ratios below the upper flammability limit without requiring the input of additional heat. Heat can be recirculated in a large scale burner, but this results in the formation of soot at high equivalence ratios. Soot is a product of incomplete combustion of hydrocarbons, consisting of fine carbon particles. Soot formation can lead to blockage in the fuel cell, reducing its performance and ultimately leading to its premature failure.

The contemplated micro-scale reformer 104 is able to avoid this problem, able to reform fuel-rich mixtures without producing soot, something that previous thermal partial oxidation reformers have consistently failed at. The contemplated micro-scale reformer 104 is able to do this as a result of limited residence time within the reformer tube 106 (i.e., elevated flow rate) and temperature control (i.e., maintaining the wall temperature of the reformer tube 106 below a critical temperature). According to various embodiments, the critical temperature is 900° C. At reforming temperatures below 900° C. in particular embodiments, precursor formation is not favorable, which restricts soot particle formation.

Achieving thermal partial oxidation without soot formation was conventionally limited to fuel/air equivalence ratios less than 1.6 for conventional fuels, due to the onset of soot formation. Advantageously, the contemplated generator 100 is able to inhibit soot production by maintaining the wall temperature below a critical temperature (e.g., 900° C.). The micro-power generator 100 disclosed herein has multiple features that help prevent the reformer tube(s) 106 from getting too hot.

The small diameter of the at least one reformer tube 106 may result in reduced residence time as well as enhanced heat transfer. Smaller tubes can lead to higher flow rates and reduced residence times, reducing the time available for soot to form. Additionally, the relationship between tube diameter and the surface area-to-volume ratio means that smaller tubes can more efficiently transfer the heat generated by combustion to the tube walls. Furthermore, some embodiments may partition the main reactor chamber 102 with a shroud 154. The shroud 154 may facilitate the transfer of heat 136 from the reformer tubes 106 and fuel cells 124 to the incoming air, providing the double benefit of cooling the reformer tube 106 while also warming the air, which can increase efficiency.

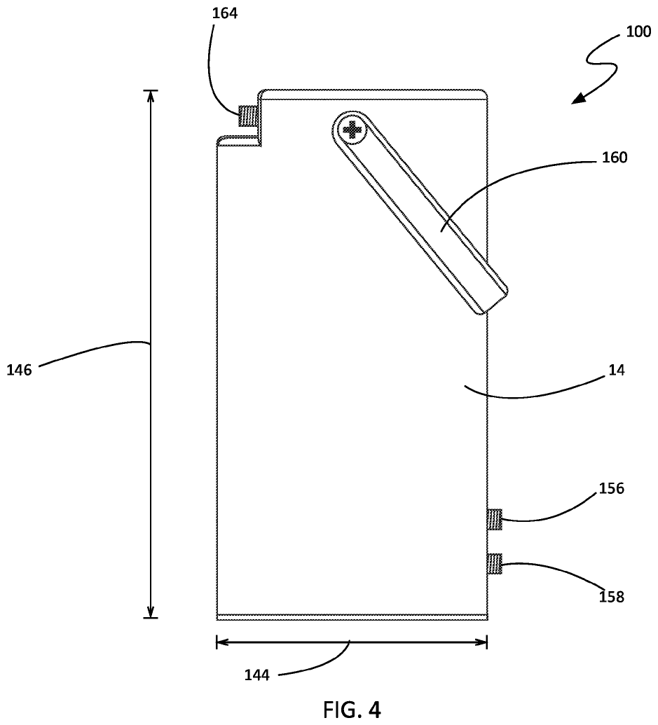

Because the micro-power generator 100 is able to inhibit soot production with these features, the equivalence ratio of the fuel/air mixture 116 does not have to be reduced. This has been demonstrated experimentally, as shown in FIG. 4, which demonstrates soot-free combustion in a reformer tube 106 at a fuel/air equivalence ratios above 2.5 without soot formation. The higher the equivalence ratio, the more efficient the micro-scale reformer 104 is in generating hydrogen-rich syngas 122 for the tubular fuel cells 124. These non-limiting conditions are ideal, as thermodynamic equilibrium favors maximum syngas 122 formation around an equivalence ratio of 2.5 to 3 for many different hydrocarbons, which has been verified in several experiments using different fuels. The ability to sustain thermal partial oxidation at high equivalence ratios without soot formation provides a distinct advantage over other SOFC generator technologies, particularly portable implementations.

Although the increased hydrogen density of the syngas 122 generated by a reformer operating on fuel-rich mixtures (i.e., high equivalence ratios) is attractive, conventional generators quickly run up against the upper flammability limit. The upper flammability limit is the maximum concentration of a gas or vapor in air above which a flame will not ignite or propagation of a flame will not occur in the presence of an ignition source. Achieving thermal partial oxidation at high equivalence ratios has been limited by the fuels'upper flammability limit in conventional technology, which also significantly reduces syngas formation. According to various embodiments, the contemplated micro-power generator 100 utilizes heat recirculation to achieve superadiabatic combustion (or flameless combustion), allowing reformation beyond the upper flammability limit. It should be noted that “superadiabatic” does not necessarily mean that temperature is constantly increasing or that it exceeds a typical adiabatic combustion temperature. Rather, it refers to a situation where heat recirculation is used to achieve higher combustion efficiency or to sustain combustion under conditions (such as ultra-rich fuel mixtures) where it would not normally be sustained.

According to various embodiments, the micro-power generator 100 achieves superadiabatic combustion by reclaiming at least part of the heat 136 produced by the electrochemical reaction occurring within the plurality of tubular fuel cells 124. As shown, the plurality of tubular fuel cells 124 are all cantilevered into the main reactor chamber 102, with one end unattached and expelling hot waste gas 132 into the main reactor chamber 102. The at least one reformer tube 106 passes through the main reactor chamber 102, where it is exposed to that heat 136. In some embodiments, one or more reformer tubes 106 pass through the main reactor chamber 102, each being exposed to the heat 136, while in other embodiments a reformer tube 106 may loop through the main reactor chamber 102. For example, in some embodiments, a reformer tube 106 may pass through the main reactor chamber 102 more than once.

The path a reformer tube 106 takes passing through the main reactor chamber 102 may be shaped such that the hot waste gas 132 impinges on the reformer tube 106. According to various embodiments, sufficient heat 136 is produced by the plurality of tubular fuel cells 124 and subsequently transferred to the at least one reformer tube 106 that the reform reaction is self-sustained superadiabatic combustion. That superadiabatic combustion allows the micro-scale reformer 104 to process much higher equivalence ratios, which results in the plurality of tubular fuel cells 124 generating a greater amount of electricity 134 and heat 136. In other words, once the plurality of tubular fuel cells 124 are producing enough heat 136 that the reform reaction becomes superadiabatic combustion, it also becomes self-sustaining.

Another advantage of superadiabatic combustion is it's sound. According to various embodiments, the superadiabatic combustion of the micro-scale reformer 104 along with the SOFC power generation of the tubular fuel cells 124 is essentially quiet, particularly in comparison to other, conventional combustion generators (e.g., 53 dB at a distance of 7 m, etc.). This may be an attractive feature for a number of potential applications, including military use cases.

Not only do these two abilities of the micro-power generator 100, operating on fuel-rich mixtures 116 in a self-sustained manner and operating without producing soot, set the contemplated micro-power generator 100 apart from conventional generators, they also depend on each other. According to various embodiments, the limited residence time and temperature control needed to inhibit soot production, particularly when operating on higher equivalence ratios, is made possible by the small size of the at least one reformer tube 106. In order to move beyond typical generators by operating on high equivalence ratios, heat reclamation is required because the small reformer tube diameter 108 (i.e., below the quenching diameter) combined with the high equivalence ratio means the reform reaction will need to be superadiabatic combustion. This is accomplished by recovering heat 136 from the waste gas 132 using the reformer tube 106, which may be facilitated by increasing the heat 136 produced by the electrochemical reaction within the plurality of tubular fuel cells 124 (i.e., reforming high equivalence ratio gas mixtures to produce hydrogen-rich syngas 122). This cycle allows the reform reaction to become self-sustaining, making the generator 100 even more resource efficient. Although an actively managed heat management system with a control is possible, it has been found that in most cases this is unnecessary and that the pre-heater and heat reclamation achieve a natural balance.

According to various embodiments, the micro-power generator 100 may be fueled with a variety of hydrocarbons. Examples include, but are not limited to, methane, natural gas, ethane, propane, butane, jet fuel (i.e., JP-8), windshield wiper fluid, and other fuels that are compatible with thermal partial oxidation to form syngas 122 or some other substance that can be used to drive an electrochemical reaction within a fuel cell, including fuels and fuel cells not yet developed.

According to various embodiments, the micro-power generator 100 comprises a plurality of tubular fuel cells 124, each tubular fuel cell 124 of the plurality of tubular fuel cells 124 comprising a first end 128, a lumen 126 or hollow that is in fluidic communication with the exhaust 112 of the micro-scale reformer 104 through the first end 128, and a second end 130 that is distal to the first end 128. As shown, the second end 130 is cantilevered into the main reactor chamber 102.

The unattached second end 130 that is cantilevered into the main reactor chamber 102 provides multiple benefits. First, it allows the tubular fuel cells 124 to eject hot waste gas 132 directly into the main reactor chamber 102, or even directly at the at least one reformer tube 106, without needing to be routed from somewhere else, saving weight and reducing lost heat 136. Additionally, the cantilevered tubular fuel cells 124 reduce thermal stresses which would be caused if the cells 124 were fixed on both ends. By leaving one end of the cell 124 free (i.e., the second end 130), the generator 100 experiences a reduction in thermal stress during heat-up and cool-down, which assists with rapid cycling.

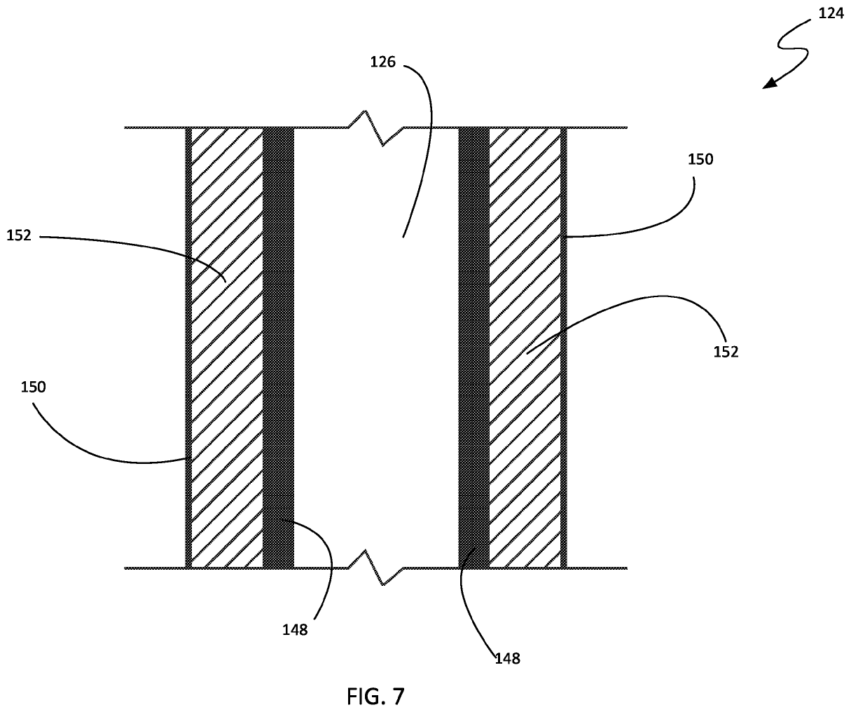

FIG. 7 is a cross-sectional view of a non-limiting example of a tubular fuel cell 124. As shown, the tubular fuel cell 124 comprises an anode 148 and a cathode 150 separated by an electrolyte 152. The anode 148 and cathode 150 are nested cylinders, giving the tubular fuel cell 124 a hollow lumen 126 running down the middle. According to various embodiments, the electrochemical reaction comprises the syngas 122 being received into the lumen 126 of each tubular fuel cell 124 through the first end 128 and the waste gas 132 being expelled into the main reactor chamber 102 through the second end 130.

According to various embodiments, the anode 148 is on the inside of the tubular fuel cell 124 such that it faces the lumen 126 and is in fluidic communication with the micro-scale reformer 104. In these embodiments, the anode 148 is in direct contact with the syngas 122 generated by the micro-scale reformer 104, which also means it could potentially be exposed to soot or other carbon deposition (e.g., coking, etc.). In some embodiments, the anode 148 may comprise nickel-yttria stabilized zirconia or similar materials. The electrolyte 152 may be any electrolyte 152 known in the art to be compatible with the anode 148, the cathode 150, and the operating environment within the micro-power generator 100 (e.g., temperature, etc.). As a specific, non-limiting example, in one embodiment, the electrolyte 152 may be yttria-stabilized zirconia (YSZ). Furthermore, according to various embodiments, the cathode 150 may be any cathode 150 known in the art to be compatible with the anode 148, the electrolyte 152, and the operating environment within the micro-power generator 100. As a specific, non-limiting example, in one embodiment, the cathode 150 may be a mixture of lanthanum strontium cobalt ferrite and samarium-doped ceria (LSCF+SDC). Other mixtures and materials are also possible.

As previously discussed, the micro-power generator 100 is configured to maintain a reformer tube 106 wall temperature on the at least one reformer tube 106, keeping the wall temperature below a critical temperature above which soot begins to form. In some embodiments, this temperature is maintained, at least in part, by modifying the flow rate within the micro-scale reformer 104. For example, in some embodiments which comprise a fan 138 (FIG. 6) to move air into the main reactor chamber 102, modifying the flow rate of the fuel/air mixture 116 may comprise modifying the speed of the fan 138. In other embodiments, that wall temperature may be maintained beneath the critical temperature by manipulating aspects of the electrochemical reaction within the fuel cells 124, such as by adjusting the fuel/air mixture 116. In still other embodiments, the wall temperature may be maintained below the critical temperature through the use of cooling devices, such as a thermoelectric cooler or the like.

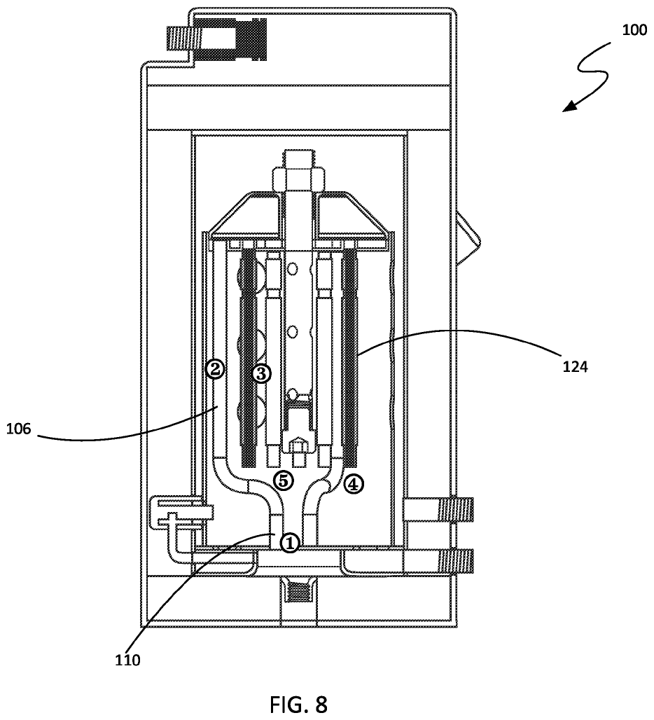

FIG. 8 is a process flow in the context of a cross-sectional view of the micro-power generator, showing the steps of a non-limiting example of a method for generating power for portable applications using a micro-power generator 100. Reference should also be made to FIG. 6 and the related description herein. First, a fuel/air mixture 116 having a flow rate and an equivalence ratio is introduced to an intake 110 of a micro-scale reformer 104. See ‘circle 1’. Mixture between the fuel and air occur in this space above the fuel coupling and may be regulated with a venturi or other passive or active regulator.

Next, syngas 122 is produced by initiating a reform reaction within the micro-scale reformer 104 where thermal partial oxidation takes place. See ‘circle 2’. The ignition is started by the preheating element 180 which is activated through an on switch (not shown) that starts the preheating element and ignites the micro-scale reformer 104.

Sufficient heat loss to the walls of the device is facilitated by the use of reformer tube(s) 106 having a reformer tube diameter 108 less than the quenching diameter specific to this context, which is on the order of less than 1-3 mm for most fuels. Diameters 108 below the quenching diameter are required to maintain the reaction with a sufficiently high equivalence ratio (i.e., superadiabatic combustion), provided heat recirculation through the reformer tube 106 is maintained. Advantageously, the implementation of additional heat recirculation accomplished through use of a reformer tube enables the use of thermal partial oxidation in a micro-scale system without the use of a steam reformer or catalyst reformer.

The syngas 122 produced by the reform reaction is expelled through an exhaust 112 of the micro-scale reformer 104 (FIG. 6). The micro-scale reformer 104 is in fluidic communication with a plurality of tubular fuel cells 124. More specifically, the exhaust 112 of the micro-scale reformer 104 is in fluidic communication with the lumens 126 of the tubular fuel cells 124.

Next, the micro-power generator 100 uses the plurality of tubular fuel cells 124 to generate electricity 134, heat 136, and a waste gas 132 through an electrochemical reaction. See ‘circle 3’. According to various embodiments, the electrochemical reaction comprises the syngas 122 being received into the lumen 126 of each tubular fuel cell 124 through the first end 128 and the waste gas 132 being expelled into the main reactor chamber 102 through the second end 130.

While this is happening, the production of soot within the micro-scale reformer 104 is being inhibited, at least in part, by maintaining the wall temperature of the at least one reformer tube 106 below a critical temperature. See ‘circle 4.’ In some embodiments, this may be accomplished, at least in part, by manipulating the flow rate of the fuel/air mixture 116.

At the same time, the reform reaction within the micro-scale reformer 104 is being made self-sustaining. See ‘circle 5’. According to various embodiments, this is accomplished and maintained with a cycle of elevating and maintaining the equivalence ratio for the fuel/air mixture 116 above a threshold ratio, thereby causing the heat 136 introduced to the at least one reformer tube 106 via the waste gas 132 produced by the electrochemical reaction and expelled into the main reactor chamber 102 to be high enough to make the reform reaction superadiabatic combustion. In some embodiments, the threshold ratio may be 2.5. In other embodiments, the threshold ratio may be a value higher than 2.5. The resulting, increased heat 136 is introduced to the at least one reformer tube 106 via the waste gas 132 expelled into the main reactor chamber 102 when the equivalence ratio is maintained above the threshold ratio.

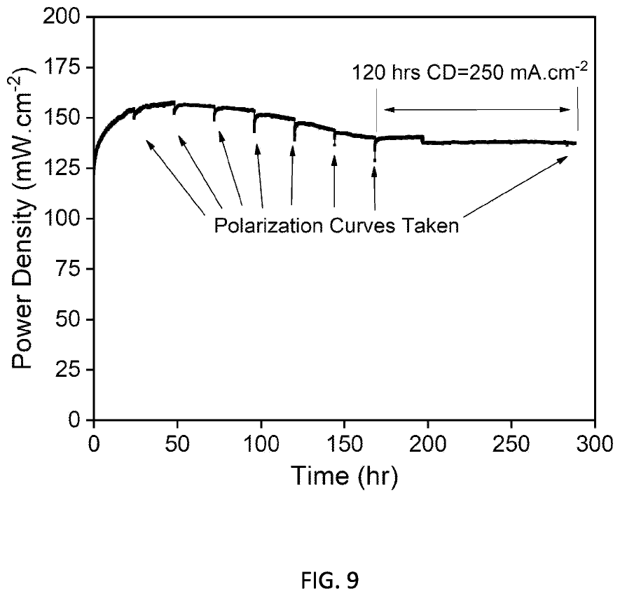

FIG. 9 is a plot of the power density over time for a particular embodiment of the micro-power generator 100. Specifically, FIG. 9 shows the power density observed in a particular embodiment during 288 hours of continuous operation at a constant current density, fueled by n-butane at 800° C. While the power density was only ˜150 mW·cm−2 for the test of this particular embodiment, the electrical efficiency exceeded 20% (in a controlled environment). As previously mentioned, the contemplated micro-power generator 100 may be adapted for use with various micro-tubular SOFCs, including micro-tubular SOFCs that have yet to be developed. It is anticipated that, for embodiments making use of micro-tubular SOFCs that have been optimized to achieve much higher performance, there may be significant improvements to the electrical efficiency (e.g., greater than 50%, etc.).

FIG. 10 is a perspective view of a non-limiting example of a micro-power generator system 300. As shown, the system 300 comprises a micro-scale reformer 104, a fuel canister 302, and a power cable 306. In some embodiments, the micro-power generator system 300 may comprise additional elements beneficial to a particular use case. For example, the system 300 shown in FIG. 3 is a specific, non-limiting example of a system 300 adapted for use in a specific military context, meeting specific performance requirements. The requirements for this specific “Soldier Power Sources” use case include: 1) 20-30 W of power in a system 300 weighing less than 6 lbs., fuel included, yielding a targeted specific energy exceeding 700 Wh/kg and power density exceeding 400 Wh/L for 72 hours of continuous operation without resupply; 2) direct micro-scale reformer/SOFC operation with JP-8 for 72 hours; and 3) ablity to startup to full load in less than 5 minutes. This specific, non-limiting example of a system 300 meets all of these requirements, having a system weight (without fuel) of 2.23 lbs. The fuel and canister needed for a 72 hour mission is estimated to weigh less than 2 lbs., resulting in a total system weight well below the target of 6 lbs.

As shown, the system 300 comprises a battery 304, specifically the Conformable Wearable Battery (CWB-150) or ‘Flexpack’ battery. Some embodiments of the system 300 comprise integration with a common battery 304 used by the Warfighter (e.g., the conformable wearable battery or the CWB 150 Flexpack, etc.). The system 300 may also include an intake hose 308 and an exhaust hose 310, which may be coupled to the intake port 156 and the exhaust port 158, respectively. These hoses allow the system 300 to be integrated into a soldier's rucksack, able to run while inside the pack without respectively obstructing the inflow of air to the intake port 156 or the venting of waste gas 132 from the exhaust port 158. In use, the fuel canister and high efficiency micro-power generator 100 could be stored in a small portion of a backpack carried by the soldier, with the intake hose 308 and exhaust hose 310 extending to outside of the backpack for access to ambient air, with the power cable 306 extending from the generator 100 to outside of the backpack to the battery 304 which can be worn in a carrier on a front of the soldier.

As a reminder, this is a specific example of a system implementation of the micro-power generator 100 contemplated herein, directed to use in a specific use case. Other embodiments of the micro-power generator system 300 may be adapted for other use cases, both military and civilian. Additional use cases will be discussed, below.

The contemplated micro-power generator 100 may provide additional advantages over conventional SOFC-based generators. These advances may include, but are not limited to, the ability to perform a rapid startup in a matter of minutes, an operational lifespan of thousands of thermal cycles, and projected reductions in cost over conventional system (e.g., less than $3/W).

Quick, timely startup is critical in some portable applications (e.g., military, emergency, and rescue applications). Slow startup was a major hindrance for a previous Army SOFC system that required 20 minutes to reach operating conditions. In some embodiments, the contemplated generator 100 has overcome that weakness, in part due to the cantilevered tubular fuel cells 124 and pre-heating burner 180.

Anode degradation is a common problem in SOFC-based generators, particularly in the long-term. Long-term performance testing (i.e., more than 280 hours) of a particular embodiment of the micro-power generator 100 using n-butane as fuel showed minor degradation (i.e., less than 0.4 mV·h−1) and no carbon deposition, a significant achievement with basic SOFC materials (e.g., nickel-yttria stabilized zirconia anode). These achievements with n-butane indicate that JP-8 is an option for direct use in the contemplated generator 100.

Through the use of a micro-power generator designs as disclosed and described herein, the micro-power generator 100 is able to achieve a low degradation rate with hydrocarbons. For example, it was discovered that the degradation rate when using butane is about the same as the U.S. Department of Energy goals for the direct use of hydrogen. This is particularly impressive without the use of a catalyst. Additionally, the micro-power generator 100 using a reformer 104, as contemplated herein, also generates some water to assist in the resistance of carbon deposition in the tube, according to various embodiments.

Other key advantages of embodiments of the micro-power generator 100 contemplated herein over traditional generator technology include reduced noise, flexible orientation during operation, low thermal signature, and rugged design. In many embodiments, the only major source of noise from the generator 100 is the small fan 138 that supplies air. The noise level is estimated to be similar to a typical small fan (e.g., ˜15 dB or less).

The micro-scale reformer 104 and tubular SOFC fuel cells 124 are insensitive to device orientation due to their micro-scale nature. Being insensitive to device orientation provides significant flexibility for wearable applications and integration with other technologies like conformal wearable batteries. Previous work by the Army indicates that prolonged contact temperatures should be low (i.e., 49° C.) to reduce the thermal signature and provide safe operation. While some embodiments of the micro-power generator 100 contemplated herein operate at high temperatures, other embodiments have achieved the desired outer temperature target of 49° C., as indicated by heat transfer models.

Embodiments contemplated herein have many potential military and civilian applications, in addition to the military applications discussed above. Civilian applications for similarly configured technology includes market demand in the areas of hiking, camping and boating, which currently utilize batteries, thermoelectric generations, and solar panels. The Bureau of Economic Analysis (BEA) found that the Outdoor Recreation Industry accounted for $374.3 billion of GDP in 2020. Embodiments of the contemplated device are well adapted for this market because they can utilize standard camping fuels such as propane, and are simple and easy to use. Other contemplated use cases include any situation where it is desirable to carry a power supply to an area where power is not readily available-particularly if the user is anticipating being in the area for an extended period of time.

There are current fuel cell systems being developed for portable and wearable applications with the specific target of generating 12-20 V of power to charge a battery. Requirements include low system weight and volume relative to the run-time, low acoustic signature, low thermal signature, ruggedized design with rapid startup capability and fuel flexibility. The current, conventional systems being developed have limited fuel flexibility, primarily because the fuel cell technology (i.e., Polymer Electrolyte Membrane) has limited ability to convert carbon-based fuels. The micro-power generator 100 contemplated herein utilizes an SOFC with reduced complexity that yields high specific energy and energy density, while also having significant fuel flexibility. The simplifications and robust micro-tubular SOFC design offer rapid startup capabilities, overcoming one of the main obstacles in previous SOFC solutions for Army applications that required over 20 min to reach operating conditions.

Where the above examples, embodiments and implementations reference examples, it should be understood by those of ordinary skill in the art that other micro-power generator devices and examples could be intermixed or substituted with those provided. In places where the description above refers to particular embodiments a micro-power generator, it should be readily apparent that a number of modifications may be made without departing from the spirit thereof and that these embodiments and implementations may be applied to other SOFC technologies as well. Accordingly, the disclosed subject matter is intended to embrace all such alterations, modifications and variations that fall within the spirit and scope of the disclosure and the knowledge of one of ordinary skill in the art.

More specifically, this disclosure, its aspects and embodiments, are not limited to the specific material types, components, methods, or other examples disclosed herein. Many additional material types, components, methods, and procedures known in the art are contemplated for use with particular implementations from this disclosure. Accordingly, for example, although particular implementations are disclosed, such implementations and implementing components may comprise any components, models, types, materials, versions, quantities, and/or the like as is known in the art for such systems and implementing components, consistent with the intended operation.

It will be understood that implementations of a high efficiency micro-power generator include but are not limited to the specific components disclosed herein, as virtually any components consistent with the intended operation of various high efficiency micro-power generators may be utilized. Accordingly, for example, it should be understood that, while the drawings and accompanying text show and describe particular high efficiency micro-power generator implementations, any such implementation may comprise any shape, size, style, type, model, version, class, grade, measurement, concentration, material, weight, quantity, and/or the like consistent with the intended operation of a high efficiency micro-power generator.

The concepts disclosed herein are not limited to the specific high efficiency micro-power generator shown herein. For example, it is specifically contemplated that the components included in particular high efficiency micro-power generators may be formed of any of many different types of materials or combinations that can readily be formed into shaped objects and that are consistent with the intended operation of the high efficiency micro-power generator. For example, the components may be formed of: rubbers (synthetic and/or natural) and/or other like materials; glasses (such as fiberglass), carbon-fiber, aramid-fiber, any combination therefore, and/or other like materials; elastomers and/or other like materials; polymers such as thermoplastics (such as ABS, fluoropolymers, polyacetal, polyamide, polycarbonate, polyethylene, polysulfone, and/or the like, thermosets (such as epoxy, phenolic resin, polyimide, polyurethane, and/or the like), and/or other like materials; plastics and/or other like materials; composites and/or other like materials; metals, such as zinc, magnesium, titanium, copper, iron, steel, carbon steel, alloy steel, tool steel, stainless steel, spring steel, aluminum, and/or other like materials; and/or any combination of the foregoing.

Furthermore, high efficiency micro-power generators may be manufactured separately and then assembled together, or any or all of the components may be manufactured simultaneously and integrally joined with one another. Manufacture of these components separately or simultaneously, as understood by those of ordinary skill in the art, may involve 3-D printing, extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, and/or the like. If any of the components are manufactured separately, they may then be coupled or removably coupled with one another in any manner, such as with adhesive, a weld, a fastener, any combination thereof, and/or the like for example, depending on, among other considerations, the particular material(s) forming the components.

In places where the description above refers to particular high efficiency micro-power generator implementations, it should be readily apparent that a number of modifications may be made without departing from the spirit thereof and that these implementations may be applied to other implementations disclosed or undisclosed. The presently disclosed high efficiency micro-power generators are, therefore, to be considered in all respects as illustrative and not restrictive.

Many additional implementations are possible. Further implementations are within the CLAIMS.

I/We claim:

1. A micro-power generator for portable applications, comprising:
a generator housing with fluid fuel inlet comprising a fuel canister connector on a surface of the generator housing;
a main reactor chamber within the generator housing;
a micro-scale reformer comprising an intake, an exhaust, and at least one reformer tube that extends through the main reactor chamber, the micro-scale reformer configured to receive a fuel/air mixture having a flow rate and an equivalence ratio through the intake, and expel hydrogen-rich synthesis gas through the exhaust, the hydrogen-rich synthesis gas produced within the micro-scale reformer through a reform reaction, the at least one reformer tube each having a diameter of 3 mm or less, and a wall temperature;
a plurality of tubular fuel cells within the main reactor chamber, each of the plurality of fuel cells coupled in a cantilevered fashion at a first end to a substrate such that a second end of each of the plurality of fuel cells, distal from the first end, is unattached from the main reactor chamber except through its association with the first end, the plurality of tubular fuel cells configured to generate electricity, heat, and a waste gas through an electrochemical reaction with the hydrogen-rich synthesis gas received from the micro-scale reformer, the waste gas being expelled into the main reactor chamber through the second end of each tubular fuel cell;
a power supply port accessible at a surface of the generator housing and configured to provide access to the electricity generated by the micro-power generator; and
a USB port accessible at a surface of the generator housing and configured to provide access to the electricity generated by the micro-power generator;
wherein the micro-power generator is configured to receive fuel through a fluid fuel inlet and convert the fuel to a hydrogen-rich synthesis gas through use of thermal partial oxidation without subsequent formation of soot;
wherein the wall temperature is less than a critical temperature; and
wherein the reform reaction is made self-sustaining, at least in part, by the heat introduced to the at least one reformer tube by the waste gas expelled into the main reactor chamber when the equivalence ratio is maintained above a threshold ratio.

2. The micro-power generator of claim 1, further comprising a fan coupled to the generator housing and configured to introduce ambient air into the main reactor chamber by drawing air through the intake.

3. The micro-power generator of claim 1, wherein the fuel is selected from the list comprising methane, natural gas, ethane, propane, butane and jet fuel.

4. The micro-power generator of claim 1, wherein the micro-power generator is insensitive to system orientation.

5. The micro-power generator of claim 1, wherein the micro-power generator is part of a system further comprising a fuel canister configured to couple to the fuel canister connector, an intake hose configured to couple to the air intake, an exhaust hose configured to couple to an air exhaust on the generator housing, a wearable battery, and a power cable configured to electrically couple to the power supply port.

6. The micro-power generator of claim 5, wherein the system has a total system weight of less than 6 lbs.

7. The micro-power generator of claim 6, wherein the generator housing comprises an outer diameter less than or equal to 3.5 inches and a length of less than or equal to 6.9 inches.

8. The micro-power generator of claim 1, wherein the micro-power generator is configured to maintain the wall temperature below the critical temperature, at least in part, by modifying the flow rate.

9. The micro-power generator of claim 1, wherein the critical temperature is 900° C.

10. The micro-power generator of claim 1, wherein the threshold ratio is 2.5.

11. The micro-power generator of claim 1, wherein the reformer tube diameter is less than a quenching diameter of the at least one reformer tube.

12. A micro-power generator for portable applications, comprising:
a main reactor chamber;
a micro-scale reformer comprising at least one reformer tube that extends through the main reactor chamber, the micro-scale reformer configured to receive a fuel/air mixture having a flow rate and an equivalence ratio through an intake, and expel syngas through an exhaust;
a plurality of fuel cells within the main reactor chamber, each of the plurality of fuel cells coupled in a cantilevered fashion at a first end to a substrate such that a second end of each of the plurality of fuel cells, distal from the first end, is unattached from the main reactor chamber except through its association with the first end, the plurality of tubular fuel cells configured to generate electricity, heat, and a waste gas through an electrochemical reaction with the syngas received from the micro-scale reformer, the waste gas being expelled into the main reactor chamber through the second end of each tubular fuel cell;
wherein the reform reaction is made self-sustaining, at least in part, by the heat introduced to the at least one reformer tube by the waste gas expelled into the main reactor chamber when the equivalence ratio is maintained above a threshold ratio, and
wherein the micro-power generator is configured to electrochemically convert the hydrogen-rich synthesis gas to generate electricity.

13. The micro-power generator of claim 12, further comprising a generator housing surrounding the micro-scale reformer, the plurality of fuel cells, the micro-power generator further comprising a fuel canister configured to couple to a fluid fuel inlet on the generator housing, an intake hose configured to couple to an air intake on the generator housing, an exhaust hose configured to couple to an air exhaust on the generator housing, a wearable battery, and a power cable configured to electrically couple to a power supply port on the generator housing and transfer electricity generated by the micro-power generator to the wearable battery.

14. The micro-power generator of claim 12, wherein the fluid fuel is selected from the list comprising methane, natural gas, ethane, propane, butane and jet fuel.

15. The micro-power generator of claim 12, further comprising a generator housing surrounding the micro-scale reformer and the plurality of fuel cells, the micro-power generator housing comprising an outer diameter less than or equal to 3.5 inches and a length of less than or equal to 6.9 inches.

16. The micro-power generator of claim 12, wherein the at least one reformer tube each having a diameter of 3 mm or less.

17. A method for generating power for portable applications using a micro-power generator, the method comprising:
introducing a fuel/air mixture having a flow rate and an equivalence ratio to an intake of a micro-scale reformer enclosed inside the micro-power generator, the micro-scale reformer comprising at least one reformer tube passing through a main reactor chamber enclosed within the micro-power generator, the at least one reformer tube having a reformer tube diameter and a wall temperature;
producing syngas by initiating a reform reaction within the micro-scale reformer, the syngas produced by the reform reaction being expelled through an exhaust of the micro-scale reformer;
generating electricity, heat, and a waste gas through an electrochemical reaction within a plurality of tubular fuel cells, each tubular fuel cell of the plurality of tubular fuel cells comprising a first end, a lumen in fluidic communication with the exhaust of the micro-scale reformer through the first end, and a second end distal to the first end and cantilevered into the main reactor chamber, wherein the electrochemical reaction comprises the syngas being received into the lumen of each tubular fuel cell through the first end and the waste gas being expelled into the main reactor chamber through the second end;
inhibiting the production of soot within the micro-scale reformer by maintaining the wall temperature of the at least one reformer tube below a critical temperature; and
making the reform reaction self-sustaining, at least in part, by elevating and maintaining the equivalence ratio above a threshold ratio, thereby causing the heat introduced to the at least one reformer tube via the waste gas produced by the electrochemical reaction and expelled into the main reactor chamber to be sufficient to make the reform reaction superadiabatic combustion.

18. The method of claim 17, wherein the at least one reformer tube passes through the main reactor chamber more than once.

19. The method of claim 17, wherein the wall temperature of the at least one reformer tube is maintained below the critical temperature, at least in part, by modifying the flow rate.

20. The method of claim 12, wherein the fuel/air mixture comprises one of methane, natural gas, ethane, propane, butane, and jet fuel.
